(19) United States
(12) Patent Application Publication
(10) Pub. No.: US 2017/0160919 A1
(43) Pub. Date: Jun. 8, 2017

(54) PERFORMING METHOD OF GRAPHIC USER INTERFACE, TRACKING METHOD OF GRAPHIC USER INTERFACE AND ELECTRONIC DEVICE USING THE SAME

(71) Applicant: INDUSTRIAL TECHNOLOGY RESEARCH INSTITUTE, Hsinchu (TW)

(72) Inventors: Ching-Hung WU, Taichung City (TW); Yu-Yu LAI, Taichung City (TW); Kuei-Chun LIU, Hsinchu City (TW); Tzi-Cker CHIUEH, Taipei City (TW)

(73) Assignee: INDUSTRIAL TECHNOLOGY RESEARCH INSTITUTE, Hsinchu (TW)

(21) Appl. No.: 14/983,190

(22) Filed: Dec. 29, 2015

(30) Foreign Application Priority Data
Dec. 3, 2015 (TW) 104140567

(51) Int. Cl. G06F 3/0488; G06F 9/44; G06F 3/0481

(52) U.S. Cl. CPC G06F 3/04883; G06F 3/04817; G06F 9/4443

(57) ABSTRACT

A performing method and a tracking method of a graphic user interface and an electronic device using the same are provided. The performing method of the graphical user interface includes the following steps. An application programming interface stored in advance is obtained. The application programming interface is unpacked to obtain a plurality of inputting actions. Each of the inputting actions has a time point. The inputting actions are adjusted according to an operating procedure to be performed, such that a plurality of virtual commands are obtained. The virtual commands are performed according to a sequence of the time points.

This application claims the benefit of Taiwan application Serial No. 104140567, filed Dec. 3, 2015, the disclosure of which is incorporated by reference herein in its entirety.

### TECHNICAL FIELD

The disclosure relates in general to a performing method of a graphic user interface, a tracking method of the graphical user interface, and an electronic device using the same.

### BACKGROUND

Along with the development of the application programs on the mobile device, there is an issue that the application programs become monopolistic. Program developer ties the users in their products via some particular services.

Instant message (IM) application is an obvious example. In different regions, the market in one region is often monopolized by one program developer. The program developer may not share the application programming interface to the public, such that the application programs become more monopolistic.

### SUMMARY

The disclosure is directed to a performing method of a graphical user interface, a tracking method of the graphical user interface, and an electronic device using the same.

According to one embodiment, a performing method of a graphical user interface is provided. The performing of the graphical user interface includes the following steps. An application programming interface which is stored in advance is obtained. The application programming interface is unpacked to obtain a plurality of inputting actions. Each of the inputting actions has a time point. The inputting actions are adjusted according to an operating procedure to be performed, such that a plurality of virtual commands are obtained. The virtual commands are performed on the graphical user interface according to a sequence of the time points.

According to another embodiment, a tracking method of a graphical user interface is provided. The tracking method of the graphical user interface includes the following steps. A plurality of sensing records are captured. Each of the sensing records has a time point. The sensing records are filtered to obtain a plurality of inputting actions. Each of the inputting actions has one of the time points. The inputting actions are packed according to a sequence of the time points of the inputting actions, to form an application programming interface. The application programming interface is stored.

According to another embodiment, an electronic device is provided. The electronic device has a graphical user interface. The electronic device includes an inputting unit, a storing unit and a controlling unit. The controlling unit includes an unpacking element, an adjusting element and a performing element. The unpacking element is configured to unpack the application programming interface to obtain a plurality of inputting actions of the inputting unit. Each of the inputting actions has a time point. The adjusting element is configured to adjust the inputting actions according to an operating procedure to be performed, such that a plurality of virtual commands are obtained. The performing element is configured to perform the virtual commands on the graphical user interface according to a sequence of the time points.

According to another embodiment, a non-transitory computer readable recording mediums for storing one or more programs is provided, the one or more programs causing a processor to perform the performing method of a graphical user interface after the program is loaded on a computer and is executed.

According to another embodiment, a non-transitory computer readable recording mediums for storing one or more programs is provided, the one or more programs causing a processor to perform the tracking method of a graphical user interface after the program is loaded on a computer and is executed.

### BRIEF DESCRIPTION OF THE DRAWINGS

FIG. 1 shows an electronic device having a graphical user interface according to an embodiment.

FIG. 2 shows a flowchart of a tracking method of the graphical user interface according to one embodiment.

FIG. 3 shows that the tracking method is performed to track a plurality of application programs according to one embodiment.

FIG. 4 shows an electronic device according to another embodiment.

FIG. 5 shows a flowchart of a performing method of the graphical user interface according to one embodiment.

FIG. 6 shows an electronic device according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

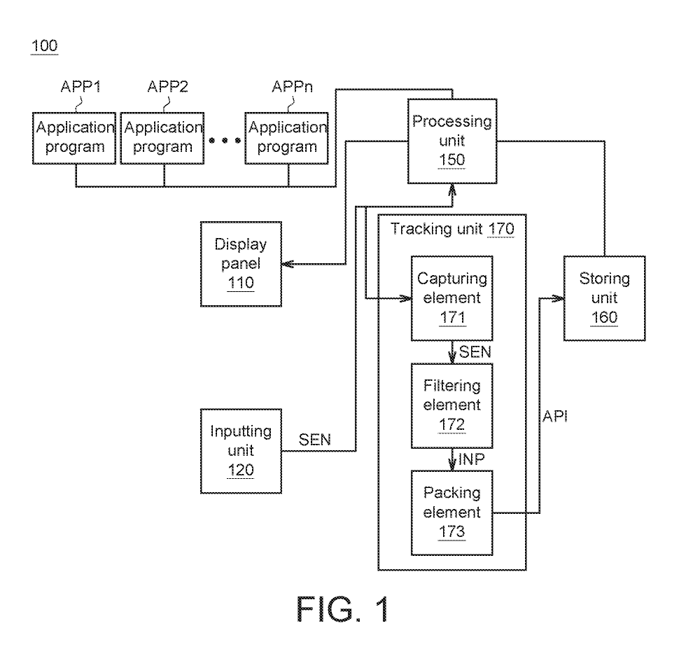

Please refer to FIG. 1. FIG. 1 shows an electronic device 100 having a graphical user interface according to an embodiment. For example, the electronic device 100 can be a smart phone, a tablet computer, a smart wearable device, or a smart appliance. The operating system of the electronic device 100 can be but not limited to Android, IOS or Windows Phone. The electronic device 100 is installed several application programs APP1, APP2, . . . , APPn. The electronic device 100 includes a display panel 110, an inputting unit 120, a processing unit 150, a storing unit 160 and a tracking unit 170.

The display panel 110 is configured to display varied kinds of information. For example, the display panel 110 can be but not limited to a liquid crystal display, an OLED display or an electronic paper.

The inputting unit 120 is configured for the user to perform varied kinds inputting actions. In one embodiment, the inputting unit 120 can be but not limited to at least one of a touch panel, a button (a power button, a snapshot button or a sound tuning button), or a sensing element (a gyroscope or a proximity sensor). The inputting actions, which are performed on the graphical user interface by the user, include but not limited to touching the touch panel, pressing the button, and actuating the sensing element. After the processing unit 150 receives the inputting actions, the operating procedures of the application programs APP1, APP2, . . . , APPn are performed accordingly, and the performing processes are shown on the display panel 110. The processing unit 150 can be but not limited to a circuit, a package chip, a circuit board, a storage device storing a plurality of program codes, or a plurality of program codes performed by a processor.

The storing unit 160 is configured to store data. For example, the storing unit 160 can be a memory or a cloud disk. The tracking unit 170 is configured to track the operating procedures of the graphical user interface. For example, the tracking unit 170 can be but not limited to a circuit, a package chip, a circuit board, a storage device storing a plurality of program codes, or a plurality of program codes performed by a processor. In one embodiment, the tracking unit 170 includes a capturing element 171, a filtering element 172, and a packing element 173. The capturing element 171 is configured to capture data from an information stream. The filter element 172 is configured to filter unnecessary data according to a particular limitation. The packing element 173 is configured to pack the inputting actions to be an application programming interface.

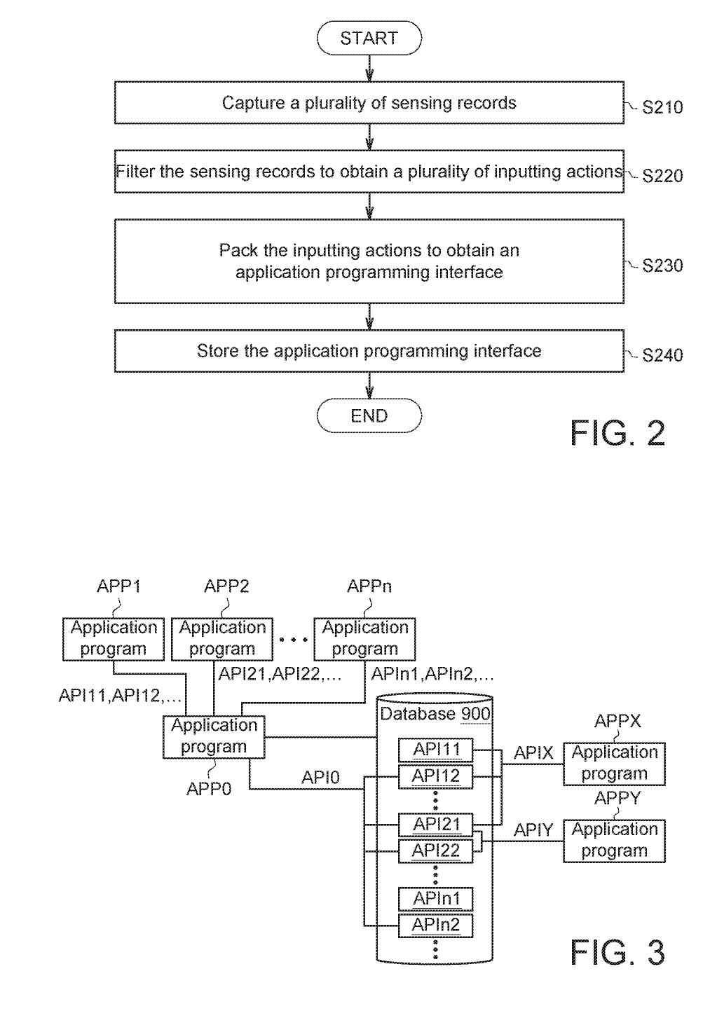

Please refer to FIGS. 1 and 2. FIG. 2 shows a flowchart of a tracking method of the graphical user interface according to one embodiment. The electronic device 100 of FIG. 1 can record the operating procedure of any application program APP1, APP2, . . . , APPn. For example, the operating procedure may be that a user sends a message to a person A via the Instant message application. A plurality of inputting actions INP in this operating procedure may be tapping a contacts list icon for showing a contacts list, tapping the person A, taping a chatroom icon, tapping a inputting message icon, tapping several keys of a virtual keyboard, and tapping a sending icon. The electronic device 100 tracks these inputting actions INP by performing the tracking method of FIG. 2. These inputting actions INP are packed to be an application programming interface API, such as Send_Msg_Line(user A).

In step S210, the capturing element 171 of the tracking unit 170 captures a plurality of sensing records SEN. The sensing records SEN are captured from the information stream between the inputting unit 120 and the processing unit 150. For example, the sensing records SEN may be but not limited to a coordinate position of a touch point of the touch pane, a key code of the button, and a signal value of the sensing element. For example, please refer to table 1, which shows some examples of the sensing records SEN. Each of the sensing records SEN may have but not limited to a time point, kind of device (touch panel, button, or sensing element), kind of input (coordinate position, key code, or trace. . . ), kind of data (X, Y, pressure, . . . ), value, etc.

TABLE 1

| | | Kind of | Kind of | Kind of | | |
|---|---|---|---|---|---|---|
| . . . | Time point | device | input | data | Value | . . . |
| . . . | 1702929874000 | 4 | 3 | 53 | 629 | . . . |
| . . . | 1702929874000 | 4 | 3 | 54 | 1302 | . . . |
| . . . | 1702929874000 | 4 | 3 | 58 | 36 | . . . |
| . . . | 1702929874000 | 4 | 0 | 0 | 0 | . . . |
| . . . | 1702937868000 | 4 | 3 | 57 | −1 | . . . |
| . . . | 1702937868000 | 4 | 0 | 0 | 0 | . . . |

Next, in step S220, the filtering element 172 filters the sensing records SEN, to obtain the inputting actions INP. In this step, the filtering element 172 can filter part of the sensing records SEN according to a particular limitation. The particular limitation is set up according to the particular application program, such that the filtering element 172 can accurately obtain some inputting actions INP relating to the particular operating procedure by filtering the sensing records SEN. The inputting actions INP have the time points too.

Afterwards, in step S230, the packing element 173 packs the inputting actions INP according to a sequence of the time points, to form the application programming interface API.

Next, in step S240, the application programming interface API is stored in the storing unit 160. As such, the user can perform the inputting actions INP on the graphical user interface again by performing the application programming interface API which is stored locally or remotely.

According to the embodiments described above, even if the application programming interface of one of the application programs APP1, APP2, . . . . , APPn cannot be obtained from the program developer, the tracking method of the graphical user interface can track the inputting actions and result the application programming interface API.

Please refer FIG. 3. FIG. 3 shows that the tracking method is performed to track a plurality of application programs APP1, APP2, . . . , APPn according to one embodiment. The program developer can track the application programs APP1, APP2, . . . , APPn via an application program APP0, to obtain a plurality of application programming interfaces API11, API12, . . . , API21, API22, . . . , APIn1, APIn2, etc. Each of the application programs APP1, APP2, . . . , APPn can be tracked more than one application programming interfaces. For example, the application program APP1 is tracked to obtain the application programming interfaces API11, API12, etc.; the application program APP2 is tracked to obtain the application programming interfaces API21, API22, etc.; the application program APPn is tracked to obtain the application programming interfaces APIn1, APIn2, etc. The application programming interfaces API11, API12, . . . , API21, API22, . . . , APIn1, APIn2, etc. are stored in a database 900. Any combination of the application programming interfaces API11, API12, . . . , API21, API22, . . . , APIn1, APIn2, etc. stored in the database 900 can achieve a new function. For example, the application program APP0 can create an application programming interface API0 to perform the application programming interfaces API12, API21, API22, APIn2. Or, another application program APPX can connect to the database 900, and create an application programming interface APIX to perform the application programming interfaces API11, API12. Or, another application program APPY can connect to the database 900, and create an application programming interface APIY to perform the application programming interfaces API21, API22.

The embodiment that several application programming interfaces API11, API12, . . . , API21, API22, . . . , APIn1, APIn2, etc. are stored in the database 900 can be applied to an internet bank application program. If one application programming interface is obtained and performed at the same mobile device, the user does not need to input the account number and the password. If one application programming interface is obtained and performed at different mobile devices, the user is asked for inputting the account number and the password.

In another embodiment, each sensing record SEN can further have a time duration. The time duration can be the interval between two sensing records SEN. In step S230, the inputting actions INP can be packed to from the application programming interface API according to the time durations.

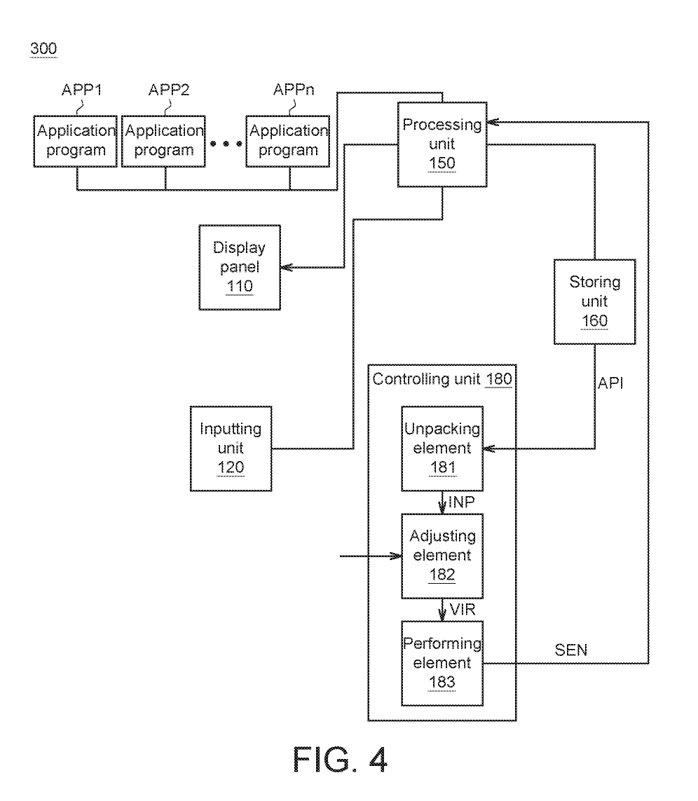

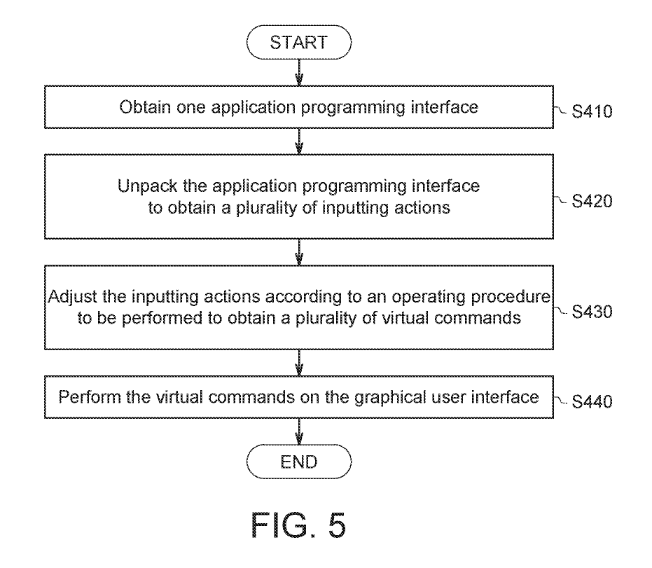

Further, the performing method of the graphical user interface is illustrated as below. Please refer to FIGS. 4 and 5. FIG. 4 shows an electronic device 300 according to another embodiment. FIG. 5 shows a flowchart of the performing method of the graphical user interface according to one embodiment. The electronic device 300 can unpack one application programming interface API to obtain a series of inputting actions INP. In one embodiment, the performing method of the graphical user interface in FIG. 5 is automatically performed.

In one embodiment, the electronic device 300 includes the display panel 110, the inputting unit 120, the processing unit 150, the storing unit 160 and a controlling unit 180. The controlling unit 180 of the electronic device 300 can perform the operating procedure of one of the application programs APP1, APP2, . . . , APPn. The controlling unit 180 includes an unpacking element 181, an adjusting element 182 and a performing element 183. For example, the controlling unit 180 can be but not limited to a circuit, a package chip, a circuit board, a storage device storing a plurality of codes, or a plurality of program codes performed by a processor.

In step S410, the controlling unit 180 obtains one application programming interface, such as Send_Msg_Line(user A), from the storing unit 160. It means the application programming interface is stored in the storing unit. In another embodiment, the application programming interface is stored in a remote storage device.

In step S420, the unpacking element 181 unpacks the application programming interface API to obtain a plurality of inputting actions INP. Each of the inputting actions INP has a time point. In another embodiment, each of the inputting actions INP can further have a time duration.

In step S430, the adjusting element 182 adjusts the inputting actions INP according to an operating procedure to be performed, such that a plurality of virtual commands VIR are obtained. For example, “Send_Msg_Line(user A)” is an application programming interface API for sending a message to the person A via the instant message application. The operating procedure to be performed is sending a message to the person B via the instant message application, i.e. “Send_Msg_Line(user B)”. In one embodiment, the adjusting element 182 can adjust the coordinate position of the touch point of the touch panel in the inputting action INP according to the resolution, such that tapping the person A can be changed to be tapping the person B. Therefore, “sending a message to the person A” can be changed to be “sending a message to the person B.” The inputting actions INP are adjusted to be the virtual commands VIR.

Or, in one embodiment, the adjusting element 182 can adjust the time duration of the each of the inputting actions INP. For example, some of the time durations which are too long can be shorten, such that the operating procedure can be smoothly performed.

In step S440, the performing element 183 performs the virtual commands VIR on the graphical user interface according to a sequence of the time points. In one embodiment, the performing element 183 continuously performs the virtual commands VIR without interruption. In one embodiment, the performing element 183 performs the virtual commands VIR according to the time durations. In one embodiment, several virtual commands VIR of one application programming interface API are performed in the same application program. When the performing element 183 performs the virtual commands VIR, the touch panel is not touched really, the button is not pressed really, and the sensing element is not actuated really. The performing element 183 simulates the sensing records SEN which are generated by the inputting actions INP.

In one embodiment, the adjusting element 182 can change or adjust the inputting actions INP according to any operating procedure to be performed, such that one application programming interface API can be expanded to perform different operating procedures.

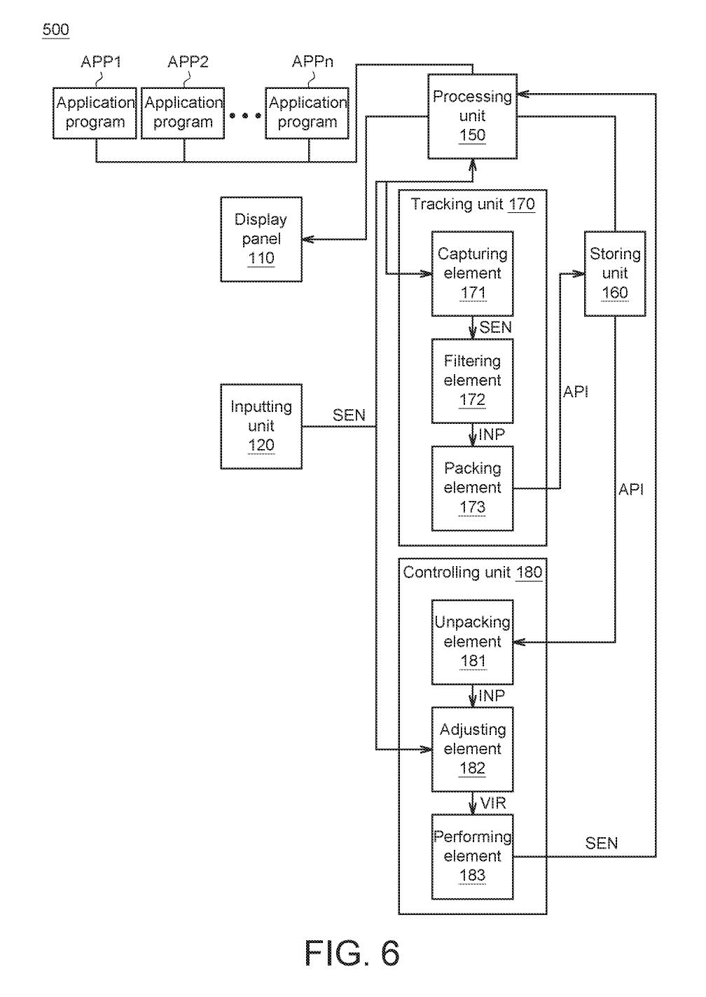

Please refer to FIG. 6. FIG. 6 shows an electronic device 500 according to another embodiment. The electronic device 500 includes the display panel 110, the inputting unit 120, the processing unit 150, the storing unit 160, the tracking unit 170, and the controlling unit 180. The electronic device 500 includes the tracking unit 170 and the controlling unit 180, so that the tracking method and the performing method of the application programs APP1, APP2, . . . , APPn can be performed.

Moreover, the program developer may want to add a particular function which is already constructed in an existing application program into a new application program. By performing the tracking method and the performing method described above, the application program can perform this particular function.

Moreover, by performing the tracking method and the performing method, some application programs relating social network, instant message (IM), financial operations and cloud network can be cooperated. For example, in the instant message, the user can make an appointment with a friend which is recorded in the contact list of the social network. Or, in the social network, the user can obtain some pictures from the cloud network. Therefore, the cooperation among different application programs can increase the service capability.

In one of exemplary examples according to the present disclosure, a non-transitory computer readable recording mediums for storing one or more programs is provided, the one or more programs causing a processor to perform the performing method of a graphical user interface after the program is loaded on a computer and is executed.

In one of exemplary examples according to the present disclosure, a non-transitory computer readable recording mediums for storing one or more programs is provided, the one or more programs causing a processor to perform the tracking method of a graphical user interface after the program is loaded on a computer and is executed.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A performing method of a graphical user interface, comprising:
obtaining an application programming interface which is stored in advance;
unpacking the application programming interface to obtain a plurality of inputting actions, wherein each of the inputting actions has a time point;
adjusting the inputting actions according to an operating procedure to be performed, such that a plurality of virtual commands are obtained; and
performing the virtual commands on the graphical user interface according to a sequence of the time points.

2. The performing method of the graphical user interface according to claim 1, wherein in the step of unpacking the application programming interface to obtain the inputting actions, the inputting actions include at least one of touching a touch panel, pressing a button, and actuating a sensing element.

3. The performing method of the graphical user interface according to claim 2, wherein in the step of adjusting the inputting actions, a coordinate position of a touch point of the touch panel is adjusted.

4. The performing method of the graphical user interface according to claim 1, wherein each of the inputting actions further has a time duration, and in the step of performing the virtual commands on the graphical user interface, the virtual commands are performed according to the time durations.

5. The performing method of the graphical user interface according to claim 1, wherein in the step of performing the virtual commands on the graphical user interface, the virtual commands are performed in one application program.

6. The performing method of the graphical user interface according to claim 1, wherein in the step of performing the virtual commands on the graphical user interface, the performing is continuous.

7. A tracking method of a graphical user interface, comprising:
capturing a plurality of sensing records, wherein each of the sensing records has a time point;
filtering the sensing records to obtain a plurality of inputting actions, wherein each of the inputting actions has one of the time points;
packing the inputting actions according to a sequence of the time points of the inputting actions, to form an application programming interface; and
storing the application programming interface.

8. The tracking method of the graphical user interface according to claim 7, wherein in the step of capturing the sensing records, the sensing records include at least one of a coordinate position of a touch point of a touch pane, a key code of a button, and a signal value of a sensing element.

9. The tracking method of the graphical user interface according to claim 7, wherein in the step of capturing the sensing records, each of the sensing records further has a time duration; in the step of packing the inputting actions to form the application programming interface, the inputting actions are packed according to the time durations.

10. An electronic device, wherein the electronic device has a graphical user interface, and the electronic device comprises:
an inputting unit;
a storing unit; and
a controlling unit, including:
a unpacking element configured to unpack an application programming interface, to obtain a plurality of inputting actions of the inputting unit, wherein each of the inputting actions has a time point;
an adjusting element configured to adjust the inputting actions according to an operating procedure to be performed, such that a plurality of virtual commands are obtained; and
a performing element configured to perform the virtual commands on the graphical user interface according to a sequence of the time points.

11. The electronic device according to claim 10, wherein the inputting unit includes at least one of a touch panel, a button and a sensing element, and the inputting actions include at least one of touching the touch panel, pressing the button, and actuating the sensing element.

12. The electronic device according to claim 11, wherein the adjusting element is configured to adjust a coordinate position of a touch point of the touch panel.

13. The electronic device according to claim 10, wherein each of the inputting actions further has a time duration, and the performing element is configured to perform the virtual commands according to the time durations.

14. The electronic device according to claim 10, wherein the performing element performs the virtual commands in one application program.

15. The electronic device according to claim 14, comprising:
a tracking unit, including:
a capturing element configured to capture a plurality of sensing records, each of the plurality of sensing records has the time point,;
a filtering element configured to filter the sensing records to obtain the inputting actions, each of the inputting actions has the time point; and
a packing element configured to pack the inputting actions according to the sequence of the time points of the inputting actions, to form the application programming interface.

16. The electronic device according to claim 15, wherein the sensing records include at least one of a coordinate position of a touch point of a touch pane, a key code of a button, and a signal value of a sensing element.

17. The electronic device according to claim 15, wherein each of the sensing records further has a time duration, and the packing element packs the inputting actions according to the time durations.

18. The electronic device according to claim 10, wherein the performing element is configured to perform the virtual commands continuously.

19. The electronic device according to claim 10, wherein the application programming interface is stored in the storing unit or is stored in a remote storage device.

20. A non-transitory computer readable recording medium for storing one or more programs, the one or more programs causing a processor to perform the method according to claim 1 after the program is loaded on a computer and is executed.

21. A non-transitory computer readable recording medium for storing one or more programs, the one or more programs causing a processor to perform the method according to claim 7 after the program is loaded on a computer and is executed.
